(19) United States
(12) Patent Application Publication
(10) Pub. No.: US 2025/0084828 A1
(43) Pub. Date: Mar. 13, 2025

(54) SYSTEM FOR GENERATING ELECTRICITY AND HYDROGEN

(71) Applicant: Andrés Fernández del Valle Camarena, Cancún (MX)

(72) Inventor: Andrés Fernández del Valle Camarena, Cancún (MX)

(21) Appl. No.: 18/566,214

(22) PCT Filed: Jun. 17, 2022
(86) PCT No.: PCT/IB2022/055667

§ 371 Date: Sep. 20, 2024

(30) Foreign Application Priority Data
Jan. 7, 2022 (MX) MX/A/2022/000375

(51) Int. Cl. F03D 9/25; C25B 1/04; C25B 9/60; F03D 9/00; H02K 7/18; H02S 10/12

(52) U.S. Cl. CPC F03D 9/25; C25B 9/60; F03D 9/007; H02K 7/183; H02S 10/12; C25B 1/04; F05B 2220/61; F05B 2220/708

(57) ABSTRACT

The present invention relates to an electric power and hydrogen generation system comprising a tower having an internal structure and an external structure, said internal and external structures being interconnected; a plurality of helical turbines each coupled to an electric generator, said turbines being arranged vertically one above the other inside the internal structure; a plurality of humidity and water collectors arranged in the interconnection spaces of said internal and external structures; the external structure presents outer surfaces, which are covered using solar cells; a tower base holds within it a system for the production, storage and supply of hydrogen and electricity.

The present invention uses different types of electric power generation from renewable sources, as well as water harvesting, to maintain a constant flow of electric power in an electrical grid and to supply hydrogen.

### TECHNICAL FIELD

Renewable energies, such as those produced by solar cells and wind systems, were initially unaffordable and still today take up too much surface area with respect to the energy they produce; their percentage efficiency is low, since they are only active intermittently, when there is either sun or wind. These facilities require specific geographical and climatic conditions for optimal operation, lack electrical autonomy due to the lack of energy storage, and have few spaces available for location in urban areas. The transfer and installation of energy generation technologies is also extremely expensive and complicated. They only produce electricity and not hydrogen.

### BACKGROUND ART

Hydroelectric plants depend on the amount of rain and the accumulation of water in reservoirs. In times of drought they do not operate constantly and are regulated by water demand, which determines whether or not they can generate energy. They also require large investments, and are considered renewable sources, but are not ecological due to the strong environmental impact they cause on flora and fauna with flooding in dams and droughts in rivers.

Oil-fired or gas-fired thermoelectric plants, coal-fired power plants with high calorific power, have a high sulfur content, with high water consumption for large capacities, and gas-fired turbo generation, gas or diesel-fired motor generation for lower scale generation using internal combustion use fossil fuels, so they require storage tanks and more space, or constant supply ducts, burning them to convert their calorific potential into electric power, they need to dissipate large amounts of heat and use noise-reduction systems, all using alternating current, with an electromagnetic alternator. In general, all energies and fossil fuels are highly polluting and emit large amounts of carbon into the environment, are finite as natural resources, and are difficult to find, extract, transport and process for consumption. Any transfer or transmission of energy causes losses and costs.

Currently known systems present problems in terms of continuity in energy delivery, as they depend directly on geographical locations, climatic variations and fuel availability; a more important variable is their high ecological and economic cost.

The problems described above are solved by means of the present invention, in an efficient, ecological and economic way.

### BRIEF DESCRIPTION OF THE INVENTION

The present invention relates to an electric power and hydrogen generation system comprising a tower having an internal structure and an external structure, said internal and external structures being interconnected; a plurality of helical turbines each coupled to an electric generator, said turbines being arranged vertically one above the other inside the internal structure; a plurality of humidity and water collectors arranged in the interconnection spaces of said internal and external structures; the external structure presents outer surfaces, which are covered using solar cells; a base of the tower holds within it a system for the production, storage and supply of hydrogen and electricity.

The present invention may present several modifications and alternative constructions, some of which are detailed in the drawings below. However, it should be clear that the intention is not to limit the invention to a particular embodiment or form, but rather the present invention should cover changes, additions and modifications as part of its scope. Independent aspects and advantages of the present invention will become apparent to those skilled in the art upon review of the detailed description and figures.

The accompanying figures are included to provide further illustration and understanding of the various aspects and embodiments, and are incorporated into and constitute a part of this description. The figures, together with the description, serve to explain the aspects and embodiments described and claimed.

### BRIEF DESCRIPTION OF THE FIGURES

The illustrative embodiment can be described with reference to the accompanying figures, whereby: FIG. 1

FIG. 1 illustrates the electric power and hydrogen generation system of the present invention, with the solar generators deployed, the wind generators and the water collectors in operation;

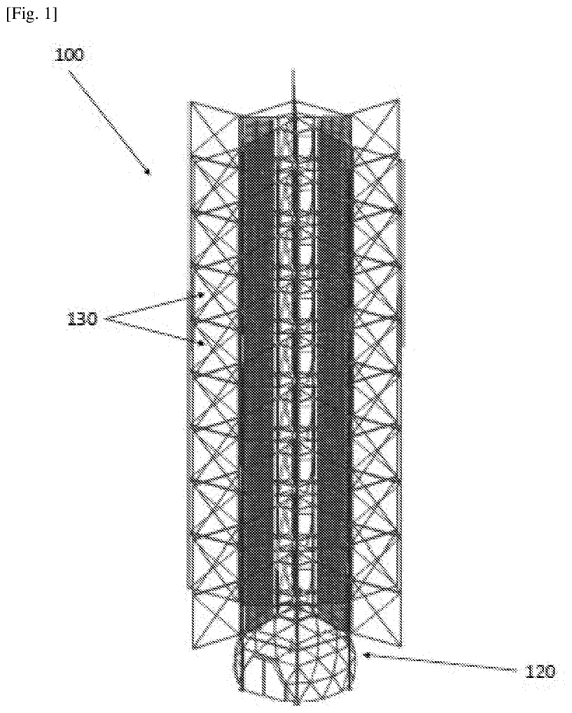

FIG. 2 illustrates the concentric structures of the electric power generation system tower and the water collectors;

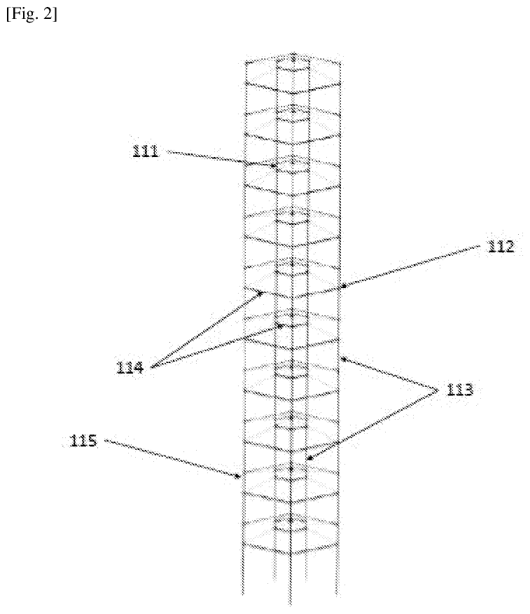

FIG. 3 illustrates the electric power generation system closed for weather protection, maintenance and repairs;

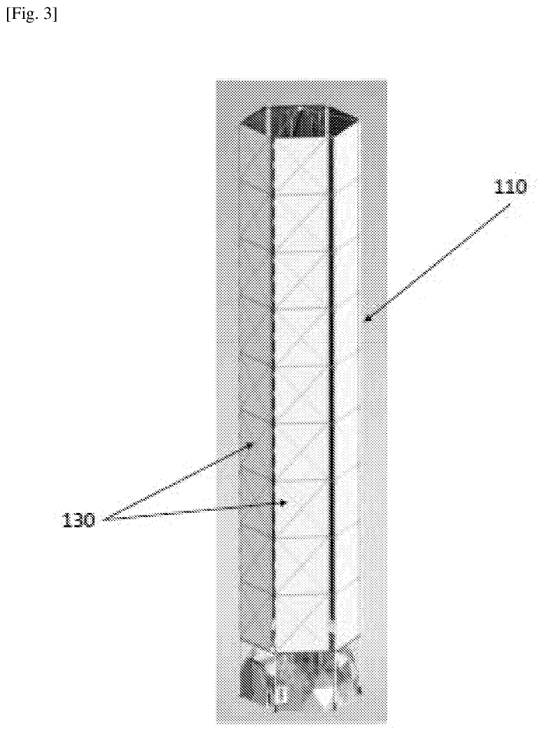

FIG. 4 illustrates an additional embodiment of the electric power generation system with the solar cells deployed, the wind generators and water collectors in operation;

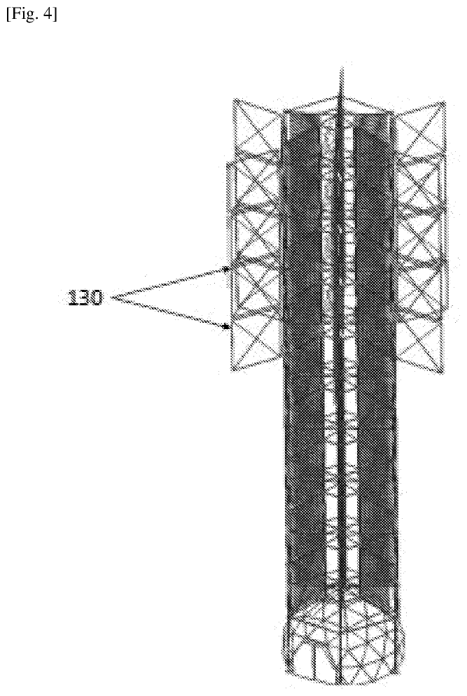

FIG. 5 illustrates a view of the base of the hydrogen and electricity production, storage and supply system with the solar cells deployed;

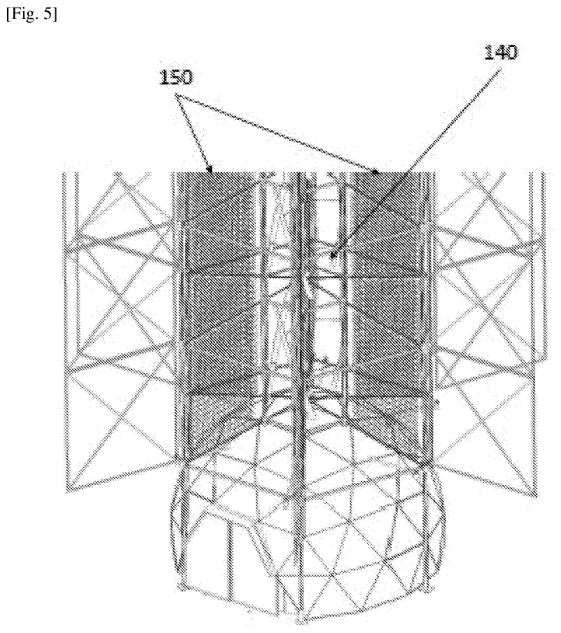

FIG. 6 illustrates a view of the base of the hydrogen and electricity production, storage and supply system;

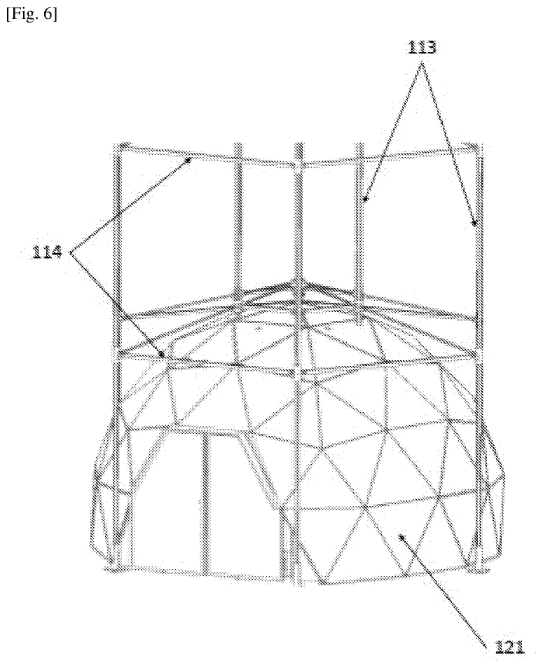

FIG. 7 illustrates a detailed view of the solar cells of the hydrogen and electricity production, storage and supply system;

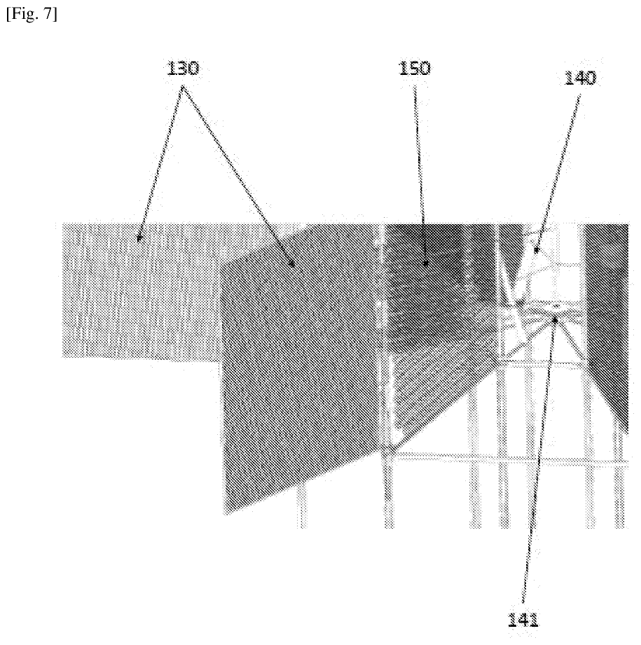

FIG. 8 illustrates a detailed view of the humidity and water collector of the hydrogen and electricity production, storage and supply system;

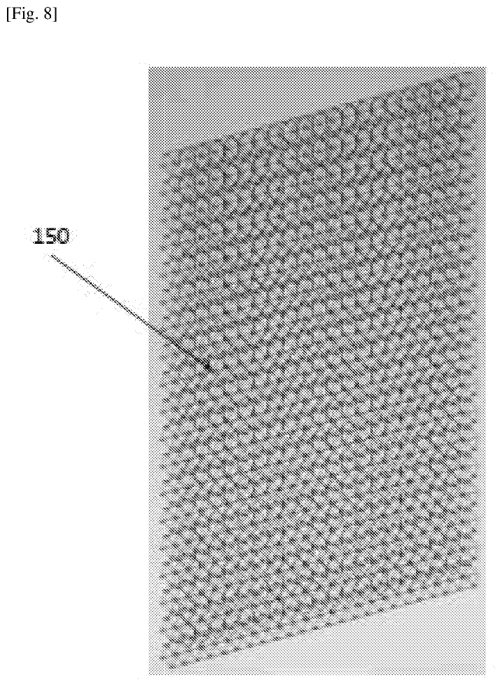

FIG. 9 illustrates a detailed view of a helical turbine of the hydrogen and electricity production, storage and supply system.

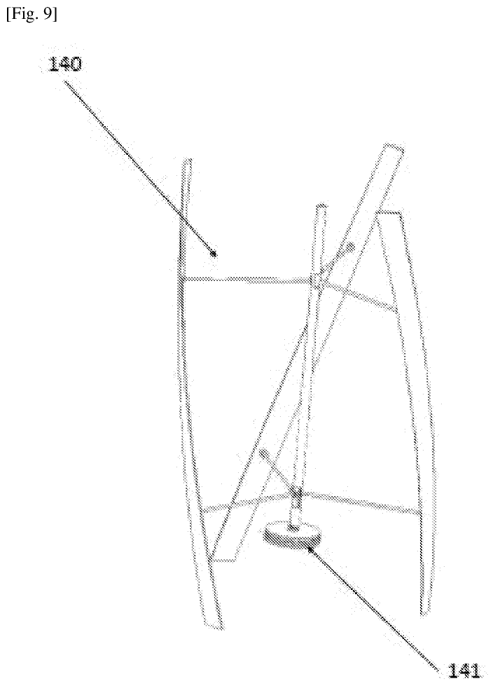

### DESCRIPTION OF AN EMBODIMENT OF THE INVENTION

### Detailed Description of the Invention

The following detailed description is exemplary only and is not intended to limit the disclosed embodiments or the application and uses of the described embodiments. As used herein, the word “exemplary” or “illustrative” means “serving as an example, instance, or illustration”. Any implementation described herein as “exemplary” or “illustrative” should not necessarily be construed as preferred or advantageous over other implementations. All of the implementations described below are exemplary implementations provided to enable those skilled in the art to make or use the embodiments of the disclosure and are not intended to limit the scope of the disclosure. In addition, for purposes of description herein, the terms “end”, “upper”, “lower”, “right”, “left”, “vertical”, “horizontal”, “lateral”, “longitudinal” and derivatives thereof are related to the invention as shown in the figures. In addition, there is no intention to be subject to any explicit or implicit theory presented in the technical field above, background, brief summary or the following detailed description. It should also be understood that the specific devices and processes illustrated in the accompanying drawings, and described in the following description, are merely exemplary embodiments of the inventive concepts defined in the attached claims.

The illustrations generally show non-limiting aspects of the systems and methods of the present description. Although the various aspects of the present descriptions of the devices should not be construed in any way as limiting the description. In addition, any modifications, concepts, and applications of aspects of the description are to be construed by those skilled in the art as comprised by, but not limited to, the illustrations and descriptions herein. Several modifications, equivalents, variants and alternatives, however, will be readily apparent to those skilled in the art. Any and all such modifications, variants, equivalents and alternatives are intended to fall within the spirit and scope of the present description.

As used herein, the singular articles “a”, “an”, and “the” include plural referents unless expressly and unambiguously limited to one referent. The term “proximal” refers to a direction toward the center or a central region of a device. The term “distal” refers to an outward direction extending away from a central region of a device. However, it is to be understood that the description may assume several alternatives, variations, and sequences of steps, except where expressly stated otherwise. It is also to be understood that the specific devices and processes illustrated in the accompanying drawings and described in the following description are non-limiting representations of several aspects of the description. Therefore, the specific dimensions and other physical characteristics related to the aspects described herein are not intended to be and should not be considered as limiting.

Unless otherwise indicated, all ranges or ratios described herein are meant to encompass any and all sub-ranges or sub-ratios incorporated herein. For example, an established range or ratio of “1 to 10” should be considered to include any and all sub-ranges between (and including) the minimum value of 1 and the maximum value of 10; that is, all sub-ranges or sub-ratios that start with a minimum value of 10 or less, such as, but not limited to, 1 to 6.1, 3.5 to 7.8, and 5.5 to 10. Unless otherwise indicated, all numbers expressing dimensions, quantities of ingredients, flow rates, pressures, etc. used in the description and claims, are to be construed as modified in all instances by the term “approximately”. For the purposes of the present description, the term “approximately” determines a range of +10%, whereby if a value of “approximately 30%” is specified, the value is within a range of 27% to 33%.

The hydrogen and electric power generation system (100) of the present invention comprises a tower (110) and a tower base (120).

The tower (110) comprises an internal structure (111) and an external structure (112), said internal (111) and external (112) structures being interconnected; said internal (111) and external (112) structures are concentric and eccentric.

Both the internal structure (111) and the external structure (112) comprise a plurality of posts (113) and crossbars with structural profiles (114); in a further embodiment, they comprise a plurality of internal tensioners; in a further embodiment, they comprise a plurality of external tensioners.

Said tower (110) has a configuration that is chosen from one of a cylindrical configuration, a frustoconical configuration, an ovoid configuration and a polygonal configuration; preferably the configuration of the tower (110) is a polygonal configuration, more preferably the polygonal configuration is a hexagonal configuration.

In one embodiment, the configuration of the internal structure (111) is the same as the configuration of the external structure (112); in a further embodiment, the configuration of the internal structure (111) is different from the configuration of the external structure (112).

The external structure (112) of the tower (110) has an outer surface (115), said outer surface uses a plurality of solar cells (130), each of the plurality of solar cells (130) are rotatably coupled to the tubular posts (113), the solar cells (130) rotate by means of one of a mechanical system, a hydraulic system and an electromechanical system, the electromechanical system comprises a control, an electric motor and one of a pulley system, a gear system, or a cam system; the rotation of the solar cells is activated individually or in groups using the control, so that the solar cells (130) fluctuate between an open position and a closed position.

The plurality of solar cells (130) are in electrical connection with an electrolyzer, where the electric power produced is stored as hydrogen.

In one embodiment, the plurality of solar cells (130) covers the entire outer surface (115) of the external structure (112) of the tower (110); in an alternative embodiment, the plurality of solar cells (130) partially covers the outer surface (115) of the external structure (112) of the tower (110).

A plurality of helical turbines (140) are located inside the internal structure (111) of the tower (110), said helical turbines (140) being arranged one above the other; each helical turbine is coupled to an electric generator (141).

The airfoil of each helical turbine is chosen from a NACA airfoil; in one embodiment, the same airfoil is selected for the plurality of helical turbines (140), in a further embodiment, more than one type of airfoil is selected for the plurality of helical turbines (140).

Because each helical turbine (140) is coupled to its own generator (141), it is possible to stop the rotation of a specific helical turbine (140) to carry out maintenance and repair operations without affecting the operation of the rest of the helical turbines (140) arranged in the internal structure (111) of the tower (110).

In the interconnection space between the internal structure (111) and the external structure (112) of the tower (110), a plurality of humidity and water collectors (150) are located, so that when the solar cells (130) are in an open position, airflow is allowed through the tower (110), so that any humidity in the air and rain is trapped in the humidity and water collectors (150).

Said humidity and water collectors (150) comprise at least two grids coupled to one another, wherein one of the grids has a smaller closing space than that of the other grid. A water recovery channel is arranged below each humidity and water collector (150) so that the condensed humidity drips into said water recovery channels and from there through pipes into a recovery tank.

The tower base (120) has a geodesic dome-type configuration (121) made up of a lightweight tubular structure; a hydrogen and electricity generator is located inside the tower; said hydrogen and electricity generator is similar to those of the state of the art, except that it has a mobile hydrogen tank and a plurality of hydrogen storage tanks with a pressure-based drip system.

The water stored in the recovery tank is used in the hydrogen and electricity generator.

In accordance with the above, the electric power and hydrogen generation system of the present invention has three different forms of electric power generation, either through solar cells, through wind turbines and through the hydrogen and electricity generator, additionally, these can operate simultaneously.

A person skilled in the art can modify the structure described herein. However, it should be noted that this description relates to preferred embodiments of the invention, and is provided for illustrative purposes only, and should not be understood as limiting the invention. All obvious modifications in the spirit of the invention, such as changes in the shape, material, and dimensions of the elements that make up the invention, should be considered within the scope of the attached claims.

The invention has been described in an illustrative manner and it should be understood that the terminology used herein is intended to correspond to the nature of the words of the description rather than to provide a limitation.

Obviously, many modifications and variations of the present invention are possible in light of the above teachings. Therefore, it should be understood that within the scope of the invention described, the invention may be practiced otherwise than specifically described.

1. Electric power and hydrogen generation system comprising:
a tower having an internal structure and an external structure, said internal and external structures being interconnected;
a plurality of helical turbines each coupled to an electric generator, said turbines being arranged vertically one above the other inside the internal structure;
the external structure presents outer surfaces, which are covered using solar cells;
a plurality of humidity and water collectors arranged in the interconnection spaces of said internal and external structures;
a tower base having within it a system for the production, storage and supply of hydrogen and electricity.

2. The system according to claim 1, wherein the tower has a configuration that is chosen from one of a cylindrical configuration, a frustoconical configuration, an ovoid configuration and a polygonal configuration.

3. The system according to claim 2, wherein the configuration of the tower is a hexagonal polygonal configuration.

4. The system according to claim 2, wherein the configuration of the internal structure is different from the configuration of the external structure.

5. The system according to claim 2, wherein the configuration of the internal structure is the same as the configuration of the external structure.

6. The system according to claim 1, wherein both the internal structure and the external structure comprise a plurality of posts and crossbars with structural profiles.

7. The system according to claim 6, wherein it additionally comprises a plurality of internal tensioners.

8. The system according to claim 6, wherein it additionally comprises a plurality of external tensioners.

9. The system according to claim 1, wherein the solar cells are rotatably coupled to the outer surface of the external structure.

10. The system in accordance with claim 9, wherein the solar cells are rotated by means of one of a mechanical system, a hydraulic system and an electromechanical system.

11. The system according to claim 10, wherein the electromechanical system comprises a control, an electric motor and one of a pulley system, a gear system or a cam system.

12. The system according to claim 1, wherein the rotation of the solar cells is activated individually.

13. The system according to claim 1, wherein the rotation of the solar cells is activated in groups.

14. The system according to claim 1, wherein said internal and external structures are concentric.

15. The system according to claim 1, wherein said internal and external structures are eccentric.

16. The system according to claim 1, wherein the plurality of helical turbines have a NACA airfoil.

17. The system according to claim 1, wherein the tower base comprises a geodesic dome.

18. The system according to claim 17, wherein the geodesic dome is made of a lightweight material.

19. The system according to claim 1, wherein the hydrogen and electricity generator has a mobile hydrogen tank and a plurality of hydrogen storage tanks with a pressure-based drip system.

20. The system according to claim 1, wherein the plurality of humidity and water collectors comprises at least two grids coupled to one another, wherein one of the grids has a smaller closing space than the other grid.
